(19) United States
(12) Patent Application Publication
(10) Pub. No.: US 2025/0148463 A1
(43) Pub. Date: May 8, 2025

(54) CLEARING METHOD AND SYSTEM WITH AUTOMATED CORRECTION

(71) Applicant: Visa International Service Association, San Francisco, CA (US)

(72) Inventors: Barbara Patterson, South San Francisco, CA (US); Millie Yee, Santa Clara, CA (US); Pinesh Roy, Foster City, CA (US); Michael Mori, San Mateo, CA (US)

(73) Assignee: Visa International Service Association, San Francisco, CA (US)

(21) Appl. No.: 18/934,781

(22) Filed: Nov. 1, 2024

Related U.S. Application Data
(60) Provisional application No. 63/595,703, filed on Nov. 2, 2023.

(51) Int. Cl. G06Q 20/40

(52) U.S. Cl. CPC G06Q 20/401

(57) ABSTRACT

A method is disclosed. The method includes receiving, by a processing network computer from a transport computer, a first clearing file comprising data for a plurality of transactions, and then determining, by the processing network computer, an authorizing entity associated with one or more transactions from the first clearing file. The method includes transmitting, by the processing network computer to an authorizing entity computer operated by the authorizing entity, a second clearing file including data for the one or more transactions, determining, by the processing network computer, that the one or more transactions include one or more anomaly transactions, and initiating, by the processing network computer, one or more transaction reversals with respect to the one or more anomaly transactions.

### CROSS-REFERENCES TO RELATED APPLICATIONS

This is a non-provisional application, which claims priority to U.S. Provisional Application No. 63/595,703 filed on Nov. 2, 2023, which is herein incorporated by reference in its entirety.

### BACKGROUND

Today, in the dual message card processing ecosystem, entities can operate in a real-time authorization plus batch based clearing and settlement flow environment. A transaction is only considered complete when it is authorized, cleared, and settled. The clearing phase is often operational, delayed, and outdated which presents integrity and logical loopholes. Uncertainty delays the clearing, which requires additional workload form the issuers and takes away from user experience. A tool to increase efficiency in the clearing process is needed.

Embodiments of the disclosure address this problem and other problems individually and collectively.

### SUMMARY

Embodiments of the invention include transaction clearing systems and methods.

One embodiment includes a method comprising: receiving, by a processing network computer from a transport computer, a first clearing file comprising data for a plurality of transactions; determining, by the processing network computer, an authorizing entity associated with one or more transactions from the first clearing file; transmitting, by the processing network computer to an authorizing entity computer operated by the authorizing entity, a second clearing file including data for the one or more transactions; determining, by the processing network computer, that the one or more transactions include one or more anomaly transactions; and initiating, by the processing network computer, one or more transaction reversals with respect to the one or more anomaly transactions.

Another embodiment includes a processing network computer comprising one or more processors, and one or more computer readable media comprising code executable by one or more processors for performing a method comprising: receiving, from a transport computer, a first clearing file comprising data for a plurality of transactions; determining an authorizing entity associated with one or more transactions from the first clearing file; transmitting to an authorizing entity computer operated by the authorizing entity, a second clearing file including data for the one or more transactions; determining that the one or more transactions include one or more anomaly transactions; and initiating one or more transaction reversals with respect to the one or more anomaly transactions

These and other embodiments are described in further detail below.

### BRIEF DESCRIPTION OF THE DRAWINGS

FIG. 1 shows a block diagram illustrating an authorization process.

FIG. 2 shows a block diagram illustrating a batch clearing process.

FIG. 3 shows a block diagram of a processing network computer according to some embodiments.

FIG. 4 shows a block diagram of a batch clearing process with automated reversals according to embodiments.

### DETAILED DESCRIPTION

Prior to discussing embodiments of the disclosure, some terms can be described in further detail.

A “resource provider” may be an entity that can provide a resource such as goods, services, information, and/or access. Examples of resource providers includes merchants, data providers, transit agencies, governmental entities, venue, and dwelling operators, etc.

A “merchant” may typically be an entity that engages in transactions and can sell goods or services, or provide access to goods or services.

“Clearing” may be a process in which a transport computer (operated by an acquirer) exchanges transaction information with an authorizing entity computer (e.g., operated by an issuer). After successful reconciliation, the transport computer generates an outgoing a clearing file various schemes (e.g., payment card networks). These schemes then break down these files in into records and processes them. The records are sent to various authorizing entity computers for settlement.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop of the user.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction such as the transaction amount, merchant identifier, merchant location, acquirer bank identification number (BIN), card acceptor ID, information identifying items being purchased, an authorization identifier (Auth TID), etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

A “processing network” may include data processing subsystems, networks, and operations used to support and deliver certificate authority services, authorization services, exception file services, and clearing and settlement services. An exemplary processing network may include VisaNet™. Processing networks such as VisaNet™ are able to process credit card transactions, debit card transactions, and other types of commercial transactions. The processing network may include a server computer. The processing network may use any suitable wired or wireless network, including the Internet.

A “server computer” may include a powerful computer or cluster of computers. For example, the server computer can be a large mainframe, a minicomputer cluster, or a group of servers functioning as a unit. In one example, the server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers.

The term “artificial intelligence model” or “AI model” may refer to a model that may be used to predict outcomes in order achieve a target goal. The AI model may be developed using a learning algorithm, in which training data is classified based on known or inferred patterns. An AI model may also be referred to as a “machine learning model.”

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines, models that classify data by establishing a gap or boundary between inputs of different classifications, as well as neural networks, collections of artificial “neurons” that perform functions by activating in response to inputs.

A transaction can be initiated when a user provides payment to a resource provider (e.g., merchant). For example, the user can make a purchase from a resource provider using a credit card. The resource provider operates a resource provider computer, which then forwards the user's payment information (e.g., via a transport computer and a processing network) in an authorization request message to an authorizing entity computer (e.g., operated by an issuer) for authorization. During authorization, the authorizing entity computer decides whether the transaction is approved or declined in real time and posts the authorization decision. The authorizing entity computer checks that the user is allowed to conduct the transaction and has sufficient funds available in their account. If the transaction is approved, the resource provider grants the user access to an item or good.

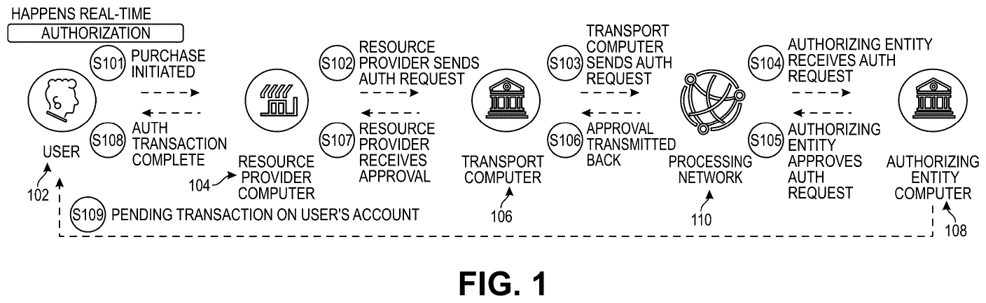

To illustrate, FIG. 1 shows a flow diagram of a payment authorization process. In FIG. 1, a user 102 provides payment during a transaction with a resource provider operating a resource provider computer 104. The user 102 may be operating a user device such as a mobile phone or card that contains a credential (e.g., a primary account number) or a token and this token may be provided to the resource provider computer 104. The resource provider computer 104 sends an authorization request message comprising the credential or the token and a transaction amount to a transport computer 106, which sends the authorization request message to an authorizing entity computer 108 via a processing network 110. The authorizing entity computer 108 may be operated by an authorizing entity such as an issuing bank, which manages an account on behalf of the user 102.

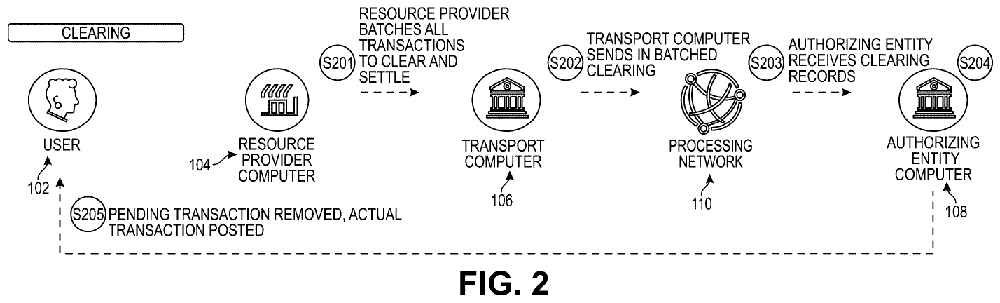

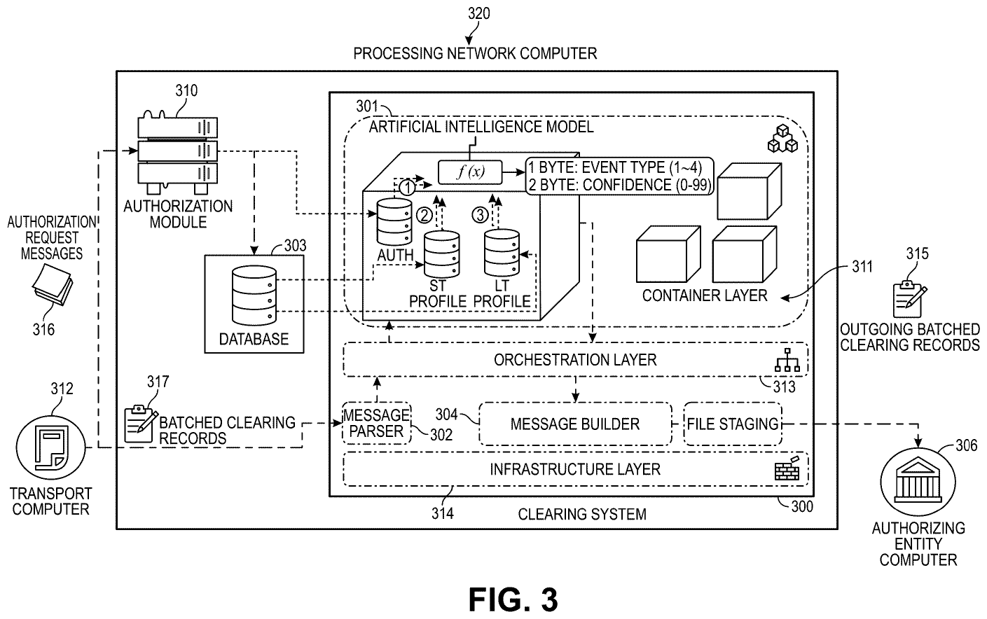

Messages between entities in FIG. 1 (as well as FIGS. 2-3) can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

More specifically, at step S101, the user 102 wishes to obtain access to a resource such as a good or service from a resource provider computer 104. The user 102 provides access data (e.g., PAN or primary account number, user credentials, cryptogram, etc.) to the resource provider computer 104, which then initiates a transaction. For example, the user 102 can tap or swipe a credit card on a merchant POS, and the merchant POS obtains payment information from the credit card. In another example, the user 102 inputs payment information to a checkout page at an e-commerce website.

At steps S102-S103, after the resource provider computer 104 receives the payment information, the resource provider computer 104 generates and transmits an authorization request message to the processing network computer 110 via a transport computer 106. The authorization request message may comprise data for the transaction such as an account identifier, a transaction value, a date and time for the transaction, service provider identifiers, transport computer identifiers, etc. The authorization request may further comprise a message type indicator to identify that the message is an authorization request message.

At step S104, after receiving the authorization request from the transport computer 106, the processing network computer 110 routes the authorization request to the authorizing entity computer 108. In some embodiments, the processing network computer 110 may modify the authorization request prior to sending it to the authorizing entity (e.g., replace a tokenized credential with a PAN).

At step S105, after receiving the authorization request from the processing network 110, the authorizing entity computer 108 makes an authorization decision and transmits the decision in an authorization response message. The decision is made in real time (e.g., within 30 seconds). The authorizing entity computer 108 may check that the user is allowed to conduct the transaction and has sufficient funds available. The authorizing entity computer 108 transmits an authorization response comprising the authorization decision back to the resource provider computer 104 in steps S105-S107. The authorization response message may additionally include an authorization code (e.g., Auth TID).

At step S108, the user 102 receives notification that the transaction is authorized. For example, the merchant POS may notify the user 102 that the payment was accepted, and the resource provider computer 104 may grant the user 102 access to the item or good.

If the transaction is authorized, at S109 the authorizing entity computer 108 places a temporary hold on the user's account. To the user 102, their available credit balance will be reduced by the hold amount, and they will see a “pending transaction” on their account. The amount of the hold is usually the same as the authorization amount except for some special cases such as in the hotel and fuel merchant categories. The hold lasts until the authorizing entity computer 108 officially posts the transaction to the user's account during clearing (e.g., as long as 7 days or more depending on the type of transaction).

Clearing enables verification of transaction data, which is important for fraud and chargeback prevention. In batch transaction processing, the clearing process occurs separately from authorization. The resource provider may collect all the transactions from that day, and send them to a transport computer (e.g., operated by an acquirer bank) to distribute to the respective authorizing entities for clearing.

FIG. 2 shows a flow diagram of a batch clearing process. Clearing can occur at the end of day or any suitable period of time, depending on the type of transaction or resource provider. FIG. 2 shows a user 102, a resource provider computer 104, a transport computer 106, a processing network computer 110, and an authorizing entity computer 108, which may be the same as shown in FIG. 1. Throughout the day, the resource provider computer 104 may conduct a plurality of transactions with various users. The clearing process shown in FIG. 2 occurs after authorization processes like those shown in FIG. 1 are complete. It verifies the transaction data, finalizes the funds, and initiates the settlement for transactions like the one described with respect to in FIG. 1.

At step S201-S202, the resource provider computer 104 collects all the transactions from the day for clearing and settlement. The resource provider computer 104 sends the batched transactions to the processing network computer 110 via the transport computer 106. The batched clearing records may be based on final transaction amounts for a plurality of transactions for that day, and may be in a clearing file that is sent from the transport computer 106 to the processing network 110.

Each clearing record in the clearing file may comprise data for the corresponding transaction such as a transaction code, an account number (e.g., a PAN), a date and time of the transaction, service provider identifiers (e.g., merchant name, merchant category code), authorization identifiers (e.g., an authorization code, an Auth TID), and a unique transaction identifier. The transaction code may indicate the type of clearing record. For example, if the transaction code is 05, it may indicate that the clearing record is for a sales draft, whereas if the transaction code is 25, it may indicate that the clearing record is for a sales draft reversal. The authorization code may be from the authorization response message (e.g., step S105 of FIG. 1) and prove that the authorizing entity computer 108 previously authorized the transaction. The unique transaction identifier in the clearing record may be from the corresponding authorization records. The unique transaction identifier can thus be used to match the clearing record to its authorization.

At step S203, the processing network computer 110 routes the clearing records to the respective authorizing entities. For example, the processing network computer 110 may organize and consolidate the clearing records based on the authorizing entity of the account that initiated the transaction. The authorizing entity computer 108 may receive clearing records for the transactions which were initiated by accounts held with authorizing entity computer 108.

At step S205, when the authorizing entity computer 108 receives the clearing records, it posts the transactions to the respective accounts, and removes previous holds. For example, for each clearing record, the authorizing entity computer 108 may identify the original matching authorization, drop the pending authorization, and officially post the transaction to the user's account. This is when the final charge shows up on the user's statement.

To match a clearing record to the original authorization, the authorizing entity computer 108 may search for authorization records with the same identifiers (e.g., a unique transaction identifier, an authorization code) as the clearing record.

The processing network computer 110 may further facilitate a settlement process to move funds between the authorizing entity computer 108 and the transport computer 106.

A duplicate clearing occurs when resource provider computer or transport computer processing errors produce two clearing records for the same authorization. A user may see a double posted charge and may be subject to a reduced availability of funds.

Duplicate clearings can be identified in a number of ways. In some embodiments, the processing network computer 110 may identify duplicate clearings as they receive them from the transport computer 106 (after step S202) using an artificial intelligence (AI) model. In some embodiments, prior to sending the clearing file to the processing network computer 110 (before step S202), the transport computer 106 may check a database and notice that there is another clearing record for the same transaction. In some embodiments, the processing network computer 110 periodically parses a transaction database to identify duplicate clearings. Some aspects of using an AI model can be found in U.S. patent application Ser. No. 18/884,692, filed on Sep. 13, 2024, which is assigned to the same assignee as the present application, and is herein incorporated by reference in its entirety for all purposes.

Once a duplicate clearing is realized, it is traditionally up to the transport computer 106 to submit a reversal to the processing network computer 110 (e.g., refund the transaction). This correction process can be slow and burdensome for the transport computer 106. Embodiments can speed up the correction process by creating refund reversals for transactions that are confirmed to be duplicates.

Embodiments can identify and alert the transport computer 106 of a duplicate transaction. Once a duplicate transaction is identified, embodiments can process a reversal transaction and route it to the associated authorizing entity computer 108. For example, when the resource provider computer 104 or transport computer 106 generates two clearing drafts for the same authorization, the processing network can identify the duplicate and create a reversal transaction message. The processing network then forwards the reversal transaction message to the authorizing entity computer 108 for correction.

In some embodiments, prior to sending the reversal clearing file to the authorizing entity computer 108 for correction, the processing network computer 110 can send the reversal transaction message to the transport computer 106 for approval. If the transport computer 106 approves, the transport computer 106 may submit the reversal.

Embodiments can relieve the transport computer 106 of handling reversal transactions, or remove the most time-consuming steps associated with initiating reversal transactions. For example, the transport computer does not need to search for the original authorization to obtain the information that goes in the reversal clearing file. As a result, embodiments allow for a frictionless correction process.

Some embodiments may incorporate a processing network computer with a technical architecture as shown in FIG. 3. FIG. 3 shows a block diagram of a processing network computer 320 in communication with an authorizing entity computer 306, and a transport computer 312. The processing network computer 320 comprises an authorization module 310, a clearing system 300 and the database 303. The processing network computer 320, authorizing entity computer 306, and transport computer 312, may be similar to FIGS. 1-2.

The processing network computer 320 can comprise one or more processors, and one or more computer readable media comprising code executable by one or more processors for performing a method comprising: receiving, from a transport computer, a first clearing file comprising data for a plurality of transactions; determining an authorizing entity associated with one or more transactions from the first clearing file; transmitting to an authorizing entity computer operated by the authorizing entity, a second clearing file including data for the one or more transactions; determining that the one or more transactions include one or more anomaly transactions; and initiating one or more transaction reversals with respect to the one or more anomaly transactions.

The authorization module 310 can comprise executable code for receiving authorization request messages 316 from transport computer 312, and storing authorization records comprising metadata associated with the authorization request messages 316 in the database 303. In various embodiments, the authorization module 310 may further comprise executable code for processing authorization request messages 316, modifying authorization request messages 316, and determining the appropriate destination (e.g., an authorizing entity computer) for the authorization request messages 316.

The clearing system 300 may comprise a container layer 311 comprising an artificial intelligence model 301, an orchestration layer 313 comprising a message parser 302 and a message builder 304, and an infrastructure layer 314. The clearing system 300 may handle the clearing and settlement of transactions. An example of the clearing system is Base II, which provides clearing, settlement, and other interchange-related services to VISA members.

The message parser 302 can comprise executable code for receiving incoming batched clearing records 317 from the transport computer 312, parsing and translating data into a desired format, and transmitting it to the artificial intelligence model 301. The message parser can parse the clearing records into individual clearing clearing files, and extract data elements from each clearing file. For example, the message parser 302 can comprise executable code for extracting data elements such as transaction amount, account identifier, resource provider identifier, etc., from batched clearing records 317.

The artificial intelligence model 301 can comprise executable code for analyzing clearing records and determining clearing scores, and transmitting the clearing score data to the message builder 304. In some embodiments, the artificial intelligence model 301 may be a neural network or a deep neural network. The artificial intelligence model 301 may be trained according to relevant features from short-term and long-term profiling databases. Example features may involve relevant historical force posts and/or relevant fraud rates from the past week (e.g., short-term profiling) and the past year (e.g., long-term profiling). Other features may include merchant category codes (MCC), transaction methods (e.g., if it was a card-not-present (CNP) transaction), the values of transactions, resource provider identifiers, transaction dates/times, clearing dates/times, settlement dates/times, geographic locations of transactions, etc. Any of these features may be converted to embeddings, which may be used to iteratively train the artificial intelligence model 301 to make appropriate predictions. In some embodiments, clearing scores may comprise a first byte to be an event type indicator, and a second and third byte to be a confidence level. This information can be in a data string comprises a first portion encoding an event type (e.g., a duplicate clearing), and a second portion encoding a score (e.g., a duplicate profiling score). The clearing system 300 can determine if the predictions that are made by the artificial intelligence model 301 were accurate or not (e.g., based on further feedback from an entity operating a transport computer or an authorization entity computer), and this feedback can be used to iteratively train the artificial intelligence model 301 so that it can learn and improve its predictions. The artificial intelligence model 301 could be trained on thousands, hundreds of thousands, or millions of transactions or features.

The message builder 304 can comprise executable code for consolidating clearing records and reversal transaction messages into outgoing files. For example, the message builder 304 can comprise executable code for receiving the clearing score data from the artificial intelligence model 301, appending clearing score data (e.g., event type and confidence) into a file with outgoing batched clearing records 315, and transmitting it to an authorizing entity computer 306. The message builder 404 may further comprise executable code for initiating reversal transactions. In various embodiments, the message builder 304 can comprise executable code for generating reversal transaction messages. For example, the message builder 304 can comprise executable code for retrieving data elements of an anomaly transaction, generating and formatting a reversal transaction message based on the anomaly transaction, and transmitting the reversal transaction message to an authorizing entity computer 306 along with outgoing batched clearing records 315. In various embodiments, the message builder 304 may comprise executable code for transmitting reversal transaction messages to the transport computer 412.

The database 303 can be a Hadoop database and can store authorization request messages 316 from transport computer 312 and authorization records comprising metadata associated with the authorization request messages 316. The data may include short term profiling historical data (e.g., data from transactions that occurred in the past 24 hours), and long term profiling historical data (e.g., averages of data over the past 12 months). All of this data, as well as other data, can be used to train the artificial intelligence model 301.

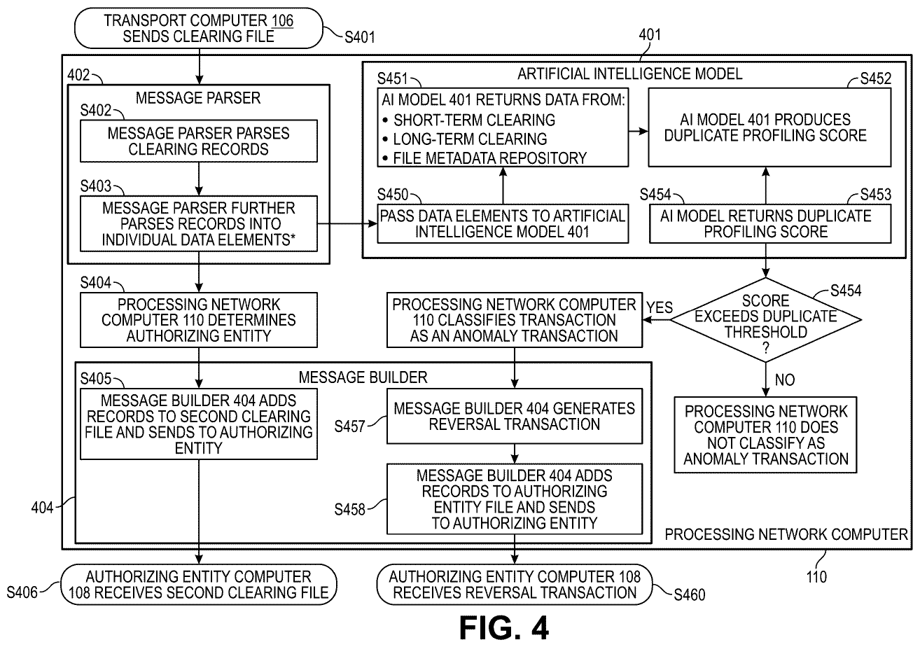

FIG. 4 shows a flow diagram of a clearing method according to embodiments. In FIG. 4, a transport computer 106 is in communication with a resource provider computer (not shown), and also an authorizing entity computer 108 via a processing network computer 110, which may be the same as shown in FIGS. 1-3. A detailed description of the method shown in FIG. 4 can be described with respect to the system of FIG. 3. The authorizing entity computer 108 can be an issuer computer, the transport computer 106 can be an acquirer computer, and the processing network computer 110 can be a payment processing network computer. The processing network computer 110 may be in communication with or comprise a message parser 402, a message builder 404, and an artificial intelligence model 401, as described above.

In step S401 the transport computer 106 may send a first clearing file through the processing network computer 110. The first clearing file may comprise data for a plurality of transactions sent from a resource provider (not shown). For example, the first clearing file may comprise a plurality of clearing records for the plurality of transactions, wherein each clearing record comprises data for a transaction such as an account number (e.g., a PAN), an authorization identifier, and a transaction value. The authorization identifier may enable the authorizing entity computer 108 to match the clearing record to the corresponding authorization (see step S406 below).

In steps S402-S403, the message parser 402 can parse the clearing file into individual clearing records, extract relevant data elements, and translate data into a desired format. Data elements may include a transaction code, a unique transaction identifier (e.g., a transaction ID), authorization codes (e.g., an Auth TID), service provider identifiers (e.g., a Merchant Name, merchant category code), a transaction value, an account identifier (e.g., a primary account number), transport computer identifiers (e.g., acquirer bank identification number, acquirer reference), a time and date of the transaction, etc. In some embodiments, the account identifier may comprise an authorizing entity identifier (e.g., an issuer BIN in the first six digits of the account identifier).

In step S404, the processing network computer 110 may determine that the authorizing entity computer 108 is associated with one or more transactions from the clearing file. The one or more transactions may involve accounts managed by the authorizing entity computer 108. For example, the processing network computer 110 may identify one or more clearing records that comprise an authorizing entity identifier (e.g., an issuer BIN in the first six digits of the account identifier) of the authorizing entity computer 108.

In step S405, the processing network computer 110 can produce a second clearing file comprising data for the one or more transactions and transmit the second clearing file to the associated authorizing entity computer 108.

In step S406, the authorizing entity computer 108 receives the second clearing file from the processing network computer 110, and the authorizing entity computer 108 can match each clearing record in the clearing file to a corresponding authorization before initiating settlement. For example, to match a clearing record to a corresponding authorization, the authorizing entity computer 108 may search for an authorization record comprising the same unique transaction identifier and a matching authorization identifier from the clearing record.

The processing network computer 110 may further facilitate a settlement process to move funds between the authorizing entity computer 108 and the transport computer 106. During settlement, the authorizing entity computer 108 can transfer the appropriate funds (e.g., the transaction value) to the transport computer 106 (e.g., via the processing network computer) and post the cleared transactions to the user's account. The funds may be associated with the transaction values for the one or more transactions.

In steps S450-S460, the processing network computer 110 determines that the one or more transactions include one or more anomaly transactions, and initiates one or more transaction reversals with respect to the one or more anomaly transactions. Steps S450-S460 may be performed by the processing network computer 110 during or after execution of steps S404-S406.

In step S450, the processing network computer 110 may input the data elements extracted from a clearing record in the first clearing file (in step S403) elements into artificial intelligence model 401.

In steps S451-S453 the artificial intelligence model 401 receives the data elements and determines a duplicate profiling score indicating the likelihood of a duplicate clearing. The artificial intelligence model 401 can also retrieve data from databases (e.g., short-term authorization data, long-term authorization data, and file metadata) to use in its determination of the score, or as additional data to accompany the score. The artificial intelligence model 401 may output the duplicate profiling score of the clearing record.

In step S454, the processing network computer 110 can use the duplicate profiling score to determine if it is an anomaly transaction. The processing network computer 110 can define a duplicate threshold. If the duplicate profiling score is above the duplicate threshold the processing network computer 110 can categorize the transaction as an anomaly transaction.

If the duplicate profiling score is under the duplicate threshold, then the processing network computer 110 may not categorize the record as an anomaly transaction. A reversal is not processed for the record if it is not an anomaly transaction, and the authorizing entity computer 108 may post the transaction as usual upon receiving the record in the second clearing file (e.g., at S406). The processing network computer 110 can proceed to check other records in the first clearing file. For example, the processing network computer 110 can repeat steps S450-S454 for each clearing record in the first clearing file to determine one or more anomaly transactions.

It should be noted that the processing network computer 110 may determine an anomaly transaction using any suitable method. In another example, the processing network computer 110 may periodically check a database (e.g., database 303 in FIG. 3) to identify anomaly transactions. For example, the processing network computer 110 can parse the database in search of two separate transactions (e.g., two separate clearing records) with the same unique transaction identifier. If the processing network computer 110 identifies two separate transactions with the same unique transaction identifier, the processing network computer 110 may classify the transaction as an anomaly transaction.

After identifying an anomaly transaction, the processing network computer traditionally notifies the transport computer 106, and the transport computer 106 generates a reversal message for the anomaly transaction. However, other embodiments can initiate, by the processing network computer 110, one or more transaction reversals with respect to the one or more anomaly transactions. Embodiments can speed up the correction process by having the processing network computer 110 create reversal transactions for a confirmed duplicate clearing. If the duplicate clearing is posted to user's account, then the processing network computer 110, rather than the transport computer 106, can prepare a reversal transaction. By creating a reversal transaction on behalf of the transport computer 106, the processing network computer 110 can improve data processing speed and reduce computational resources relative to conventional processes by reducing the numbers of messages that are transmitted and can reduce friction.

In step S457, after determining one or more anomaly transactions, the processing network computer 110 can generate one or more reversal transaction messages with respect to the one or more anomaly transactions. Each reversal transaction message can comprise a reversal transaction indicator in a transaction code data field which indicates that the message is a reversal transaction message. For each anomaly transaction, the processing network computer 110 may identify a plurality of data elements from the clearing record (which may be the extracted data elements from step S403) and format them into a reversal transaction message. Data elements may include account number (e.g., a PAN), transaction date, transaction value, resource provider identifiers (e.g., a merchant name, a merchant category code), authorization identifiers (e.g., an authorization code), and a unique transaction identifier.

In step S458, the processing network computer 110 can initiate the transaction reversal by transmitting the one or more reversal transaction messages to the authorizing entity computer 108. The one or more reversal transaction messages may be sent with the second clearing file in step S406 or in a later clearing file, depending on when the processing network computer 110 identifies the one or more anomaly transactions. For example, in some embodiments, if the processing network computer 110 identifies that the first clearing file contains one or more anomaly transactions prior to transmitting the second clearing file to the authorizing entity computer 108 in step S405, the processing network computer 110 may transmit the reversal transaction messages for the one or more anomaly transactions to the authorizing entity computer 108 in the same clearing cycle. The processing network computer 110 can also notify the transport computer 106 that it has automatically initiated the transaction reversal processes with respect to the anomalous transactions.

In other embodiments, prior to transmitting the one or more reversal transaction messages to the authorizing entity computer 108, the processing network computer 110 can provide the transport computer 106 with relevant reversal transaction data for approval. The reversal data may be formatted (e.g., include all of the necessary data elements for reversal transactions) such that the transport computer 106 can easily submit the one or more reversal transaction messages to initiate reversal transactions after evaluating them. The transport computer 106 can then promptly process the refund reversal without having to manually search for the relevant reversal transaction data. If the transport computer 106 approves, the processing network computer 110 can proceed with step S458.

In step S460, after receiving the one or more reversal transaction messages from the processing network computer 110, the authorizing entity computer 108 may process the one or more reversal transactions with respect to the one or more anomaly transactions. For example, if the authorizing entity computer 108 receives the one or more reversal transaction messages after settlement of the one or more anomaly transactions, the authorizing entity computer 108 may remove the double posted charge associated with the one or more anomaly transactions. If the authorizing entity computer 108 receives the one or more reversal transaction messages with the second clearing file (e.g., in step S406) and/or prior to settlement, the authorizing entity computer 108 can avoid doubly posting the one or more anomaly transactions.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a processing network computer from a transport computer, a first clearing file comprising data for a plurality of transactions;
determining, by the processing network computer, an authorizing entity associated with one or more transactions from the first clearing file;
transmitting, by the processing network computer to an authorizing entity computer operated by the authorizing entity, a second clearing file including data for the one or more transactions;
determining, by the processing network computer, that the one or more transactions include one or more anomaly transactions; and
initiating, by the processing network computer, one or more transaction reversals with respect to the one or more anomaly transactions.

2. The method of claim 1, wherein initiating a transaction reversal in the one or more transaction reversals comprises:
determining, by the processing network computer, data for an anomaly transaction in the one or more anomaly transactions, wherein the data for the anomaly transaction comprises an account number, a unique transaction identifier, an authorization identifier, and a transaction value;
generating, by the processing network computer, a reversal transaction message comprising a reversal transaction indicator in a transaction code data field, the account number, the unique transaction identifier, the authorization identifier, and the transaction value; and
transmitting, by the processing network computer, the reversal transaction message to the authorizing entity computer.

3. The method of claim 2, wherein the data for the plurality of transactions comprises the data for the anomaly transaction.

4. The method of claim 2, wherein the method further comprises:
prior to transmitting the reversal transaction message to the authorizing entity computer, transmitting, by the processing network computer to the transport computer, the reversal transaction message; and
receiving, by the processing network computer from the transport computer, the reversal transaction message.

5. The method of claim 1, wherein the one or more anomaly transactions are determined to have duplicate profiling scores exceeding a threshold, and wherein the duplicate profiling scores are determined by an artificial intelligence model.

6. The method of claim 5, wherein the processing network computer comprises the artificial intelligence model.

7. The method of claim 6, wherein the artificial intelligence model is a deep neural network.

8. The method of claim 1, wherein the one or more anomaly transactions are duplicate transactions determined by the processing network computer checking a database for anomaly transactions.

9. The method of claim 8, wherein the processing network computer comprises the database, and wherein the database stores data related to a plurality of authorization request messages, wherein each authorization request message is associated with an authorization identifier.

10. The method of claim 1, further comprising: facilitating, by the processing network computer, a settlement process between the authorizing entity computer and the transport computer, the settlement process involving transaction values associated with at least the one or more transactions.

11. A processing network computer comprising:
one or more processors; and
one or more computer readable media comprising code executable by the one or more processors to perform a method comprising:
receiving, from a transport computer, a first clearing file comprising data for a plurality of transactions;
determining an authorizing entity associated with one or more transactions from the first clearing file;
transmitting to an authorizing entity computer operated by the authorizing entity, a second clearing file including data for the one or more transactions;
determining that the one or more transactions include one or more anomaly transactions; and
initiating one or more transaction reversals with respect to the one or more anomaly transactions.

12. The processing network computer of claim 11, wherein the method further comprises:
facilitating, by the processing network computer, a settlement process between the authorizing entity computer and the transport computer, the settlement process involving transaction values associated with at least the one or more transactions.

13. The processing network computer of claim 11, wherein the data for the plurality of transactions comprises unique transaction identifiers, account identifiers, authorization identifiers, and transaction values for the plurality of transactions.

14. The processing network computer of claim 11, wherein the one or more computer readable media further comprise an artificial intelligence model, a container layer, an orchestration layer, a database, and a message builder, and wherein the artificial intelligence model is in the container layer.

15. The processing network computer of claim 14, wherein the one or more anomaly transactions are determined to have duplicate profiling scores exceeding a threshold, and wherein the duplicate profiling scores are determined by the artificial intelligence model.

16. The processing network computer of claim 14, wherein the artificial intelligence model is a deep neural network.

17. The processing network computer of claim 14, wherein the method further comprises:
building, using the message builder, one or more reversal transaction messages with respect to the one or more anomaly transactions, wherein each reversal transaction message comprises a reversal transaction indicator in a transaction code data field, an account number, an authorization identifier, and a transaction value.

18. The processing network computer of claim 17, wherein the initiating one or more transaction reversals comprises transmitting the one or more reversal transaction messages to the authorizing entity computer.

19. The processing network computer of claim 14, wherein the database stores data related to a plurality of authorization request messages, wherein each authorization request message is associated with an authorization identifier.

20. The processing network computer of claim 19, wherein the one or more anomaly transactions are duplicate transactions determined by the processing network computer checking the database for anomaly transactions.
